(19) United States
(12) Patent Application Publication
(10) Pub. No.: US 2003/0164016 A1
(43) Pub. Date: Sep. 4, 2003

(54) Solubility fertilizer compounds and compostions

(76) Inventors: Menachem Bar-On, Arad (IL); Alexander Yosef, Arad (IL); Yaakov Oren, Arad (IL); Isaac Zuckerman, Arad (IL)

Correspondence Address: John P White, Cooper & Dunham, 1185 Avenue of the Americas, New York, NY, 10036, US

(21) Appl. No.: 10/240,365

(22) PCT Filed: Mar. 29, 2001
(86) PCT No.: PCT/IL01/00297

(30) Foreign Application Priority Data
Apr. 3, 2000 (IL) 135432

(51) Int. Cl. C05B 1/00

(52) U.S. Cl. 71/33

(57) ABSTRACT

Fertilizer compositions, comprising at least one double salt of the formula XH₅(PO₄)₂, wherein X is K or NH₄. The double salt may be KH5(PO₄)₂ (HKP) or (NH₄)H₅(PO₄)₂ (HAP). The fertilizer compositions may further contain other nutrient components that nay he chosen from the group consisting of calcium nitrate, calcium phosphate, and chelated and/or non-chelated micronutrients. The chelated and/or non-chelated micronutrients may be chosen from the group consisting of salts of iron, manganese, copper, zinc und molybdenum.

### FIELD OF THE INVENTION

This invention relates to water soluble fertilizer compositions containing nitrogen, potassium and phosphorus, give clear solutions with a low pH.

### BACKGROUND OF THE INVENTION

Fertilizer compositions containing nitrogen, phosphorus and potassium, indicated as NPK, have been described in the art as based on the use of urea. WO 92/13813 proposes fertilizer compositions which contain urea phosphate and additional important nutrients such as calcium.

U.S. Pat. No. 4,456,463 discloses a fertilizer composition which contains urea phosphate products. The urea phosphate can be obtained in relatively pure form by the reaction of urea with wet process phosphoric acid by methods well known in the fertilizer industry.

Water soluble fertilizers should provide a low pH solution to prevent turbidity and/or precipitation of solid material. Fertilizer compositions containing urea phosphate (UP) can provide a sufficiently low pH. The use of urea or urea phosphate, however, is not free of disadvantages. In particular, there are applications, e.g. in greenhouses, in which it is not permitted to introduce urea. Furthermore, solutions of fertilizer compositions containing urea are more turbid then is desirable.

It is a purpose of this invention to provide novel fertilizer compositions that contain nitrogen, potassium and phosphorus, viz. are NPK, and are free of the disadvantages of known NPK fertilizer compositions.

Another purpose of this invention is to provide such compositions which are rapidly and completely soluble and form solutions that do not suffer from turbidity or precipitation of solid substances.

It is a further purpose to provide such compositions which form solutions that remain clear even when containing calcium nitrate or phosphate and/or non-chelated and chelated salts of metals such as Mg, Zn, Fe, Cu, Mn and the like.

It is a still further purpose to provide such compositions which can be stored without losing the aforesaid properties.

It is a still further purpose to provide such compositions which do not contain urea phosphate.

It is a still further purpose to provide such compositions which contain calcium and/or magnesium salts.

It is a still further purpose to provide double salts of monoammonium phosphate (MAP) or monopotassium phosphate (MKP) and their use in NPK fertilizer compositions.

Other purposes and advantages of this invention will appear as the description proceeds.

### SUMMARY OF THE INVENTION

The invention provides fertilizer compositions characterized in that they comprise at least one double salt of the formula XH₅(PO₄)₂, wherein X is K or NH₄. Particularly, the invention provides fertilizer compositions that comprise KH₅(PO₄)₂, hereinafter HKP, and/or (NH₄)H₅(PO₄)₂, hereinafter HAP.

Preferably, the fertilizer compositions also contain other nutrient components, chosen from among calcium, preferably in the form of calcium nitrate or calcium phosphate, chelated and non-chelated micronutrients, such as iron, manganese, copper, zinc and molybdenum.

The invention further comprises the aforesaid double salts of the formula XH₅(PO₄)₂, wherein X is K or NH₄. Said double salts are KH₅(PO₄)₂, hereinafter HEP, and (NH₄)H₅(PO₄), hereinafter HAP. HKP contains 60 wt % of P₂O₅ and HAP contains 61 wt % of P₂O₅.

The invention further comprises the novel use of said double salts in fertilizer compositions.

### DETAILED DESCRIPTION OF PREFERRED EMBODIMENTS

The following examples illustrate the invention, but are not intended to limit it in anyway.

### EXAMPLE 1

### Preparation of HP (KH₂PO₄—H₃PO₄)

A clear solution is prepared by mixing and heating to 70° C. the following components:

| | |
|---|---|
| Phosphoric acid, technical (67.5 wt % P₂O₅) | 3004.9 g |
| KH₂PO₄ crystals, technical | 2400 g |
| Water | 595.1 g |
| Total | 6000.0 g |

The resulting solution contains:

P₂O₅ wt % 54.4

K₂O wt % 14.0

Molar ratio K/P 3.39

The solution is cooled under constant stirring, in a controlled manner, at a rate of 10° C. per hour. At 50° C., 15 g of KH₅(PO₄)₂ crystals are added for seeding purposes. The cooling is continued while stirring, until a temperature of 25° C. is reached. At that temperature, the suspension is separated in a centrifuge into 2120 g of crystals and 3850 g of mother liquor. The crystals are washed in the centrifuge with 220 g of water. The composition of said crystals is:

P₂O₅ wt % 60.4

K₂O wt % 20.0

Humidity wt % 0.7

The crystals have the following granular sizes distribution, expressed in weight percentages:

Size 2 mm-3.3

Size 1 mm-52.3

Size 0.5 mm-35.1

Size less than 0.5 mm-5.3

In the mother liquor are found:

47.8 wt % P₂O₅ and 10.0 wt % K₂O

### EXAMPLE 2

### Preparation of HAP Monohydrate (H₄H₂PO₄H₃PO₄H₂O)

A clear solution is prepared by mixing and heating to 85° C. the following components:

| | |
|---|---|
| Phosphoric acid, technical (67.5 wt % P₂O₅) | 3361.5 g |
| MAP, technical (NH₄H₂PO₄)- | 2200.05 g |
| Water | 433.5 g |
| Total | 6000.0 g |

The resulting solution has the following composition:

P₂O₅ 60.5 wt %

NH₃ 5.4 wt %

Molar ratio NIP=0.37

The solution is cooled under continuous stirring, in a controlled manner, at a rate of 10° C. per hour. At 35° C., 20 g NH₄H₅(PO₄)₂.H₂O crystals are added for seeding purposes. The cooling is continued while stirring until a temperature of 25° C. is reached. At this temperature, the suspension is separated in a centrifuge into 2500 g of crystals and 3250 g of mother water. The crystals (NH₄H₅(PO₄)₂H₂O) are washed in the centrifuge with 200 g of water. The composition of said crystals is:

P₂O₅ 61.2 wt %

N 6.0 wt %

Moisture 1 wt %

In the mother liquor are found:

P₂O₅ 57.0 wt %

NH₃ 3.6 wt %

The double salts according to the invention, and the fertilizer compositions containing them, are very suitable for soils with high pH and for hard water irrigation. Water having a high pH reduces the nutrient availability of the soil and consequently the nutrient uptake by the plant. An NPK such as that according to the invention, which acidifies the water, renders the nutrient completely accessible to the plants. The acidity of the product increases the solubility compared to a conventional NPK and saves the need of nitric or phosphoric acid to lower the pH. For this reason, an NPK according to the invention is preferable to a conventional NPK.

The amount of HKP or HAP in the fertilizer compositions of the invention will vary, depending upon the potassium nutrients content in the formula of the NPK Usually, one can use the same formulations in which monopotassium phosphate (MKP) or monoammonium phosphate (MAP) are used, but substituting HKP for MKP and HAP for MAP.

Since the HKP contributes P₂O₅ and K₂O and HAP contributes P₂O₅ in a precise stoichiometric ratio to the dry NPK mixture, it may be necessary to add additional P₂O₅, N₂O in the case of HKP, or to add additional P₂O₅ and nitrogen in the case of HAP, to alter the ratio provided by the HEP or the HAP alone.

A solid product of the invention should contain at least about 5% by weight of HKP or HAP The HEP contributes by itself 3 P₂O₅ and 1% K₂O. The HAP contributes by itself 3% P₂O₅ and 0.3 nitrogen. The solid product can contain up to about 95% by weight of the HP or HAP. The HKP contributes by itself 57% P₂O₅ and 19% K₂O. The HAP contributes 58% P₂O₅ and 5.7% nitrogen. A higher nutrients content can be achieved by the addition of various nutrient sources such as KNO₂, K₂SO₄ and KCl for K₂O and MAP for nitrogen.

The preferred fertilizer formulations according to the invention have the following ranges of content moieties: 0.3-40% nitrogen, 1-25% K₂O and 3-60% P₂O₅.

The effect of preventing precipitation from solutions, which the double salts of this invention have, is illustrated by the following Table I, which lists the behavior of solutions of Ca(NO₃)₂, Mg(NO₃)₂ and/or metal sulfates, together with MAP, compared to the same solutions containing HAP or HKP.

TABLE I

| | | No Precipitate |
|---|---|---|
| Example | Precipitate Occurred | Occurred |
| A | 2 gr of MAP + 100 gr of | 2 gr of HKP or HAP + 100 gr |
| | calcium nitrate/liter | of calcium nitrate/liter* |
| B | 10 gr of MAP + 10 gr of | 10 gr of HKP or HAP + 10 gr |
| | calcium nitrate/liter | of calcium nitrate/liter |
| C | 100 gr of MAP + 100 gr | 100 gr of HKP or HAP + 100 |
| | of calcium nitrate/liter | gr of calcium nitrate/liter |
| D | 10 gr of MAP + 10 gr of | 10 gr of HKP or HAP + 10 gr |
| | ferrous sulfate/liter | of ferrous sulfate/liter |
| E | 100 gr of MAP + 100 gr | 100 gr of HKP or HAP + 100 |
| | of ferrous sulfate/liter | gr of ferrous sulfate/liter |
| F | 150 gr of MAP + 150 gr | 150 gr of HKP or HAP + 150 |
| | of calcium nitrate + 150 | gr of calcium nitrate + 150 gr |
| | gr of magnesium nitrate/ | of magnesium nitrate/liter |
| | liter | |
| G | 100 gr of MAP + 100 gr | 100 gr of HKP or HAP + 100 |
| | of ferrous sulfate + 30 | gr of ferrous sulfate + 30 gr of |
| | gr of manganese | manganese sulfate + 10 gr of |
| | sulfate + 10 gr of copper | copper sulfate + 40 gr of zinc |
| | sulfate + 40 gr of zinc | sulfate/liter |
| | sulfate/liter | |
| H | 50 gr of MAP + 95 gr of | 50 gr of HKP or HAP + 95 gr |
| | calcium nitrate + 1.0 gr | of calcium nitrate + 1.0 gr |
| | ferrous sulfate + 0.5 gr | ferrous sulfate + 0.5 gr of |
| | of manganese sulfate + | manganese sulfate + 0.25 gr of |
| | 0.25 gr of copper | copper sulfate + 0.5 gr of zinc |
| | sulfate +0.5 gr of zinc | sulfate/liter |
| | sulfate/liter | |

Additionally, solutions were prepared containing 1 gram of HKP or HAP and 100, 200, 300, 400, 500, 600, 700, 800, 900 and 1000 grams of Ca(NO₃)₂ per liter of solution, and no precipitate occurred in any of the solutions.

According to embodiments of the invention, it is possible, as evidenced by the above data, to prepare e.g. solid calcium/phophorus fertilizers, which can be successfully formed into stable stock solutions having weight compositions as follows:

| | | |
|---|---|---|
| Calcium Nitrate | 0.1 to 99% | 5 to 95% |
| HKP | 0.1 to 99% | 5 to 95% |
| Other fertilizer materials | 0 to 75% | 0 to 75% |

While specific embodiments of the invention have been described for the purpose of illustration, it will be understood that the invention may be carried into practice by skilled persons with many modifications, variations and adaptations, without departing from its spirit or exceeding the scope of the claims.

1. Fertilizer compositions, comprising at least one double salt of the formula XH₅(PO₄)₂, wherein X is K or NH₄.

2. Fertilizer compositions according to claim 1, wherein the double salt is KH₅(PO₄)₂ (HKP).

3. Fertilizer compositions according to claim 1, wherein the double salt is (NH₄)H₅(PO₄)₂ (HAP).

4. Fertilizer compositions according to claim 1, further containing other nutrient components.

5. Fertilizer compositions according to claim 4, wherein the other nutrient components are chosen from the group consisting of calcium nitrate, calcium phosphate, and chelated and/or non-chelated micronutrients.

6. Fertilizer compositions according to claim 5, wherein the chelated and/or non-chelated micronutrients are chosen from the group consisting of salts of iron, manganese, copper, zinc and molybdenum.

7. Use of double salts of the formula XH₅(PO₄)₂, wherein X is K or NH₄, for the preparation of fertilizer compositions, substantially as described in the specification.

8. Use of double salts according to claim 7, wherein the double salt is KH₅(O₄)₂ (HKP).

9. Use of double salts according to claim 7, wherein the double salt is (NH₄)H₅(PO₄)₂ (HAP).

10. As a new compound, KH₅(PO₄)₂ (HEP). [Is this acceptable phrasing]

11. As a new compound, (NH₄)H₅(PO₄)₂ (HAP).

12. Process for making KH₅(O₄)₂ (HKP), which comprises the steps of preparing a solution by mixing and heating under stirring phosphoric acid and monopotassium phosphate, cooling the solution under stirring and separating the HKP by centrifugation.

13. Process for making NH₂PO₄H₃PO₄H₂O, which comprises the steps of preparing a solution by mixing and heating phosphoric acid and monoammonium phosphate, cooling the solution and separating the HAP by centrifugation.

14. Fertilizer compositions, substantially as described and exemplified.

15. Process for making fertilizer compositions, substantially as described and exemplified.
